(19) United States
(12) Patent Application Publication
(10) Pub. No.: US 2023/0209327 A1
(43) Pub. Date: Jun. 29, 2023

(54) NETWORK SELECTION FOR A ROAMING USER EQUIPMENT

(71) Applicant: QUALCOMM Incorporated, San Diego, CA (US)

(72) Inventors: Sebastian SPEICHER, Wallisellen (CH); Haris ZISIMOPOULOS, London (GB)

(21) Appl. No.: 17/996,479

(22) PCT Filed: Mar. 29, 2021
(86) PCT No.: PCT/US2021/070324

§ 371 Date: Oct. 18, 2022

(30) Foreign Application Priority Data
Apr. 21, 2020 (GR) 20200100202

(51) Int. Cl. H04W 8/12; H04W 60/04

(52) U.S. Cl. CPC H04W 8/12; H04W 60/04; H04W 84/042

(57) ABSTRACT

Various aspects of the present disclosure generally relate to wireless communication. In some aspects, a user equipment (UE) may receive an indication of one or more standalone nonpublic network (SNPN) roaming groups, associated with a network to which the UE is subscribed, and one or more SNPNs to which the UE is not subscribed. The UE may determine that a transmission from an SNPN identifies an SNPN roaming group identifier associated with one of the one or more SNPN roaming groups or identifies an SNPN identifier associated with one of the one or more SNPNs. The UE may register with the SNPN based at least in part on determining that the transmission identifies the SNPN roaming group identifier or the SNPN identifier. Numerous other aspects are provided.

### CROSS-REFERENCE TO RELATED APPLICATION

This Patent Application claims priority to Greece Patent Application No. 20200100202, filed on Apr. 21, 2020, entitled “NETWORK SELECTION FOR A ROAMING USER EQUIPMENT,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for network selection for a roaming user equipment (UE).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LIE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LIE and NR technologies. Preferably, these improvements should be applicable to other multiple access technologies and the telecommunication standards that employ these technologies.

### SUMMARY

In some aspects, a method of wireless communication, performed by a user equipment, may include receiving an indication of one or more standalone non-public network (SNPN) roaming groups, associated with a network to which the UE is subscribed, and one or more SNPNs to which the UE is not subscribed; determining that a transmission from an SNPN identifies an SNPN roaming group identifier associated with one of the one or more SNPN roaming groups or identifies an SNPN identifier associated with one of the one or more SNPNs; and registering with the SNPN based at least in part on determining that the transmission identifies the SNPN roaming group identifier or the SNPN identifier.

In some aspects, a method of wireless communication, performed by a UE, may include receiving an indication of a network-type preference relating to public land mobile networks (PLMNs) or SNPNs; and determining to register with a network based at least in part on the network-type preference.

In some aspects, a UE for wireless communication may include a memory and one or more processors operatively coupled to the memory. The memory and the one or more processors may be configured to receive an indication of one or more SNPN roaming groups, associated with a network to which the UE is subscribed, and one or more SNPNs to which the UE is not subscribed; determine that a transmission from an SNPN identifies an SNPN roaming group identifier associated with one of the one or more SNPN roaming groups or identifies an SNPN identifier associated with one of the one or more SNPNs; and register with the SNPN based at least in part on determining that the transmission identifies the SNPN roaming group identifier or the SNPN identifier.

In some aspects, a UE for wireless communication may include a memory and one or more processors operatively coupled to the memory. The memory and the one or more processors may be configured to receive an indication of a network-type preference relating to PLMNs or SNPNs; and determine to register with a network based at least in part on the network-type preference.

In some aspects, a non-transitory computer-readable medium may store one or more instructions for wireless communication. The one or more instructions, when executed by one or more processors of a UE, may cause the one or more processors to receive an indication of one or more SNPN roaming groups, associated with a network to which the UE is subscribed, and one or more SNPNs to which the UE is not subscribed; determine that a transmission from an SNPN identifies an SNPN roaming group identifier associated with one of the one or more SNPN roaming groups or identifies an SNPN identifier associated with one of the one or more SNPNs; and register with the SNPN based at least in part on determining that the transmission identifies the SNPN roaming group identifier or the SNPN identifier.

In some aspects, a non-transitory computer-readable medium may store one or more instructions for wireless communication. The one or more instructions, when executed by one or more processors of a UE, may cause the one or more processors to receive an indication of a network-type preference relating to PLMNs or SNPNs; and determine to register with a network based at least in part on the network-type preference.

In some aspects, an apparatus for wireless communication may include means for receiving an indication of one or more SNPN roaming groups, associated with a network to which the apparatus is subscribed, and one or more SNPNs to which the apparatus is not subscribed; means for determining that a transmission from an SNPN identifies an SNPN roaming group identifier associated with one of the one or more SNPN roaming groups or identifies an SNPN identifier associated with one of the one or more SNPNs; and means for registering with the SNPN based at least in part on determining that the transmission identifies the SNPN roaming group identifier or the SNPN identifier.

In some aspects, an apparatus for wireless communication may include means for receiving an indication of a network-type preference relating to PLMNs or SNPNs; and means for determining to register with a network based at least in part on the network-type preference.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a block diagram conceptually illustrating an example of an SNPN, in accordance with various aspects of the present disclosure.

FIGS. 4A-4C are diagrams illustrating examples of SNPN access, in accordance with various aspects of the present disclosure.

FIG. 5 is a diagram illustrating an example of SNPN roaming, in accordance with various aspects of the present disclosure.

FIGS. 6A and 6B are diagrams illustrating one or more examples of discovery and selection of an SNPN based at least in part on an SNPN roaming group, in accordance with various aspects of the present disclosure.

FIGS. 7 and 8 are diagrams illustrating examples of network selection for a roaming UE, in accordance with various aspects of the present disclosure.

FIGS. 9 and 10 are diagrams illustrating example processes performed, for example, by a UE, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

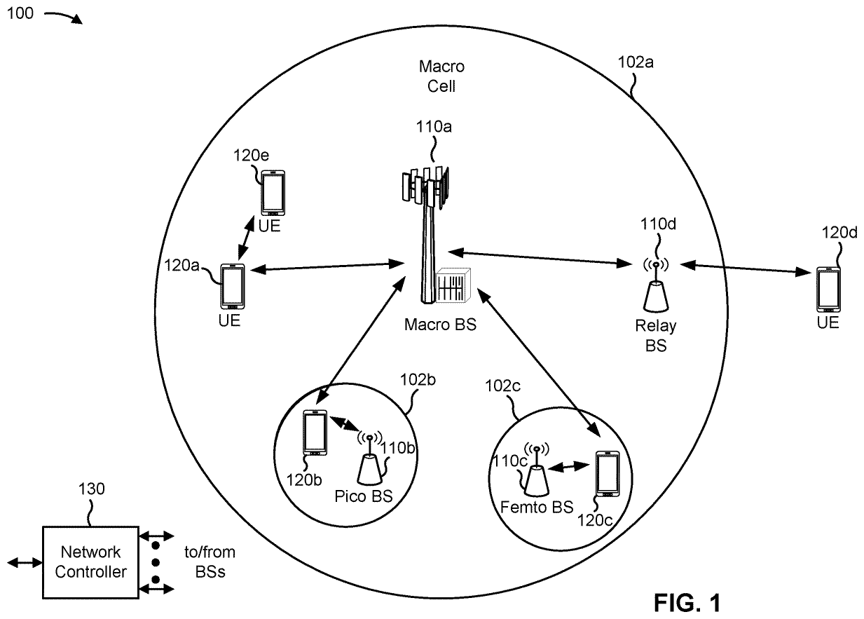

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

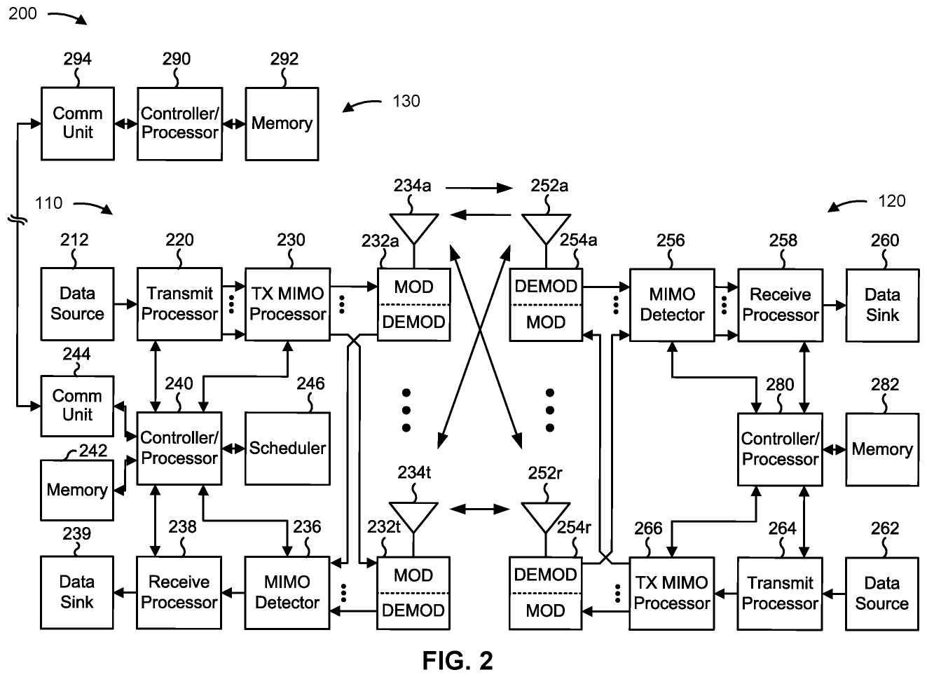

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

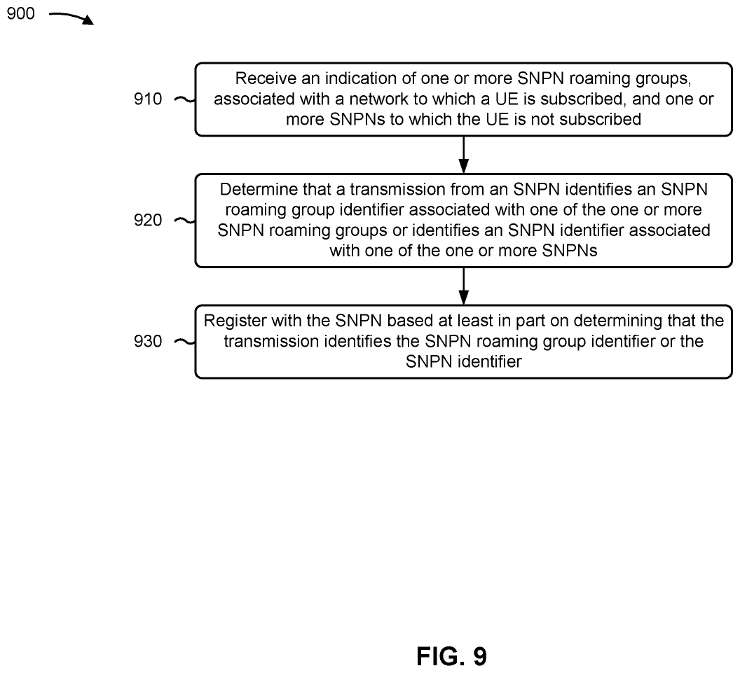

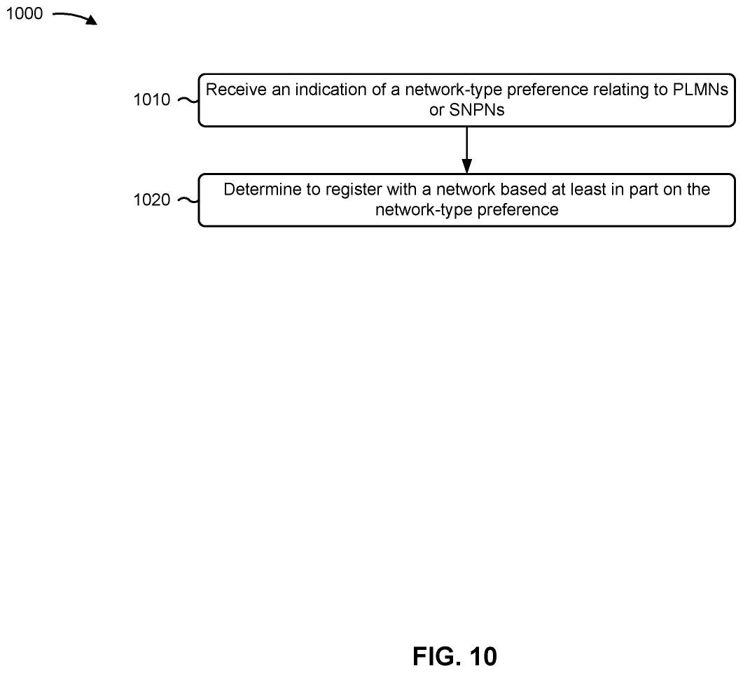

Controller/processor 240 of base station 110, controller/processor 280 of UE 120, and/or any other component(s) of FIG. 2 may perform one or more techniques associated with network selection for a roaming UE, as described in more detail elsewhere herein. For example, controller/processor 240 of base station 110, controller/processor 280 of UE 120, and/or any other component(s) of FIG. 2 may perform or direct operations of, for example, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 900 of FIG. 9, process 1000 of FIG. 10, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, UE 120 may include means for receiving an indication of one or more SNPN roaming groups, associated with a network to which UE 120 is subscribed, and one or more SNPNs to which UE 120 is not subscribed, means for determining that a transmission from an SNPN identifies an SNPN roaming group identifier associated with one of the one or more SNPN roaming groups or identifies an SNPN identifier associated with one of the one or more SNPNs, means for registering with the SNPN based at least in part on determining that the transmission identifies the SNPN roaming group identifier or the SNPN identifier, means for receiving an indication of a network-type preference relating to PLMNs or SNPNs, means for determining to register with a network based at least in part on the network-type preference, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

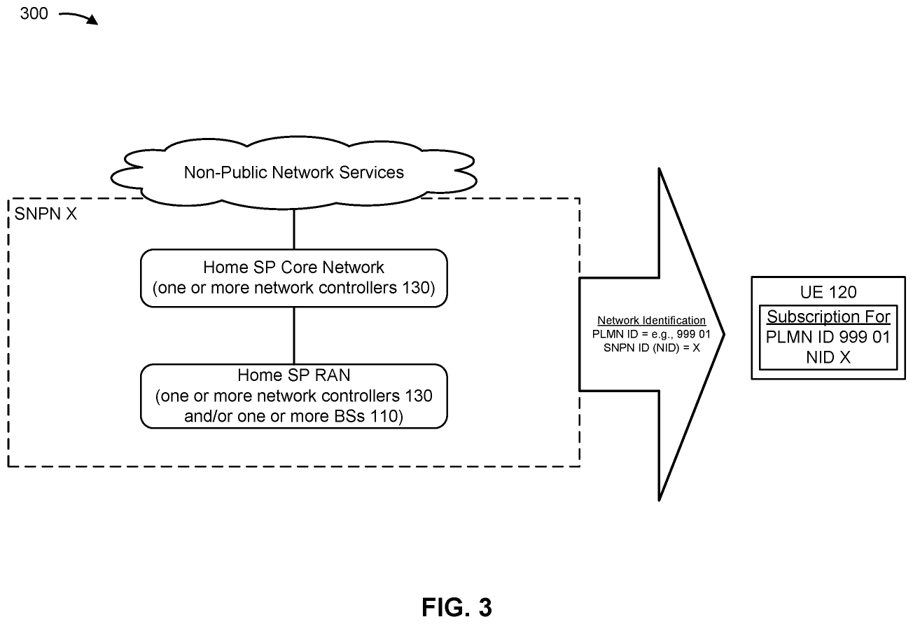

FIG. 3 is a diagram illustrating an example 300 of an SNPN, in accordance with various aspects of the present disclosure. An SNPN is a dedicated, private wireless network (e.g., a 5G network or another type of wireless network) that may be associated with an enterprise, a facility, or another entity or site. For example, an SNPN may be associated with a particular corporate campus, a particular factory, a particular industrial facility, and/or the like.

As shown in FIG. 3, an SNPN (e.g., referred to as SNPN X in FIG. 3) may be implemented in and by a wireless network, which may be referred to as a home service provider (home SP) wireless network for a UE (e.g., a UE 120). In this case, a core network and a radio access network (RAN) of the home SP may be configured to provide the SNPN to the UE and/or other UEs that are permitted to access the SNPN.

The core network may include one or more network controllers 130 that provide various core network functions, such as a Network Slice Selection Function (NSSF), a Network Exposure Function (NEF), an Authentication Server Function (AUSF), a Unified Data Management (UDM) function, a Policy Control Function (PCF), an Application Function (AF), an Access and Mobility Management Function (AMF), a Session Management Function (SMF), a User Plane Function (UPF), an Inter-Working Function (IWF), and/or the like. The RAN may include one or more network controllers 130 and/or one or more BSs 110 that provide wireless coverage to UEs that access the home SP.

In some cases, access to the SNPN may be limited to UEs having subscriptions to the SNPN. In this case, a UE may be provisioned and/or otherwise configured with subscription information associated with the SNPN so that the UE can use the subscription information to register with the SNPN. As shown in FIG. 3, the subscription information may include a public land mobile network (PLMN) identifier associated with the home SP and an SNPN identifier (e.g., which may be referred to as a network identifier (NID)) associated with the SNPN. In some cases, the SNPN (e.g., one or more BSs 110 in the SNPN) may configure the UE with the subscription information as part of a subscriber identity module (SIM) over-the-air (OTA) update procedure and/or another type of provisioning procedure. The UE may receive the subscription information and may store the subscription information in a SIM component, a universal integrated circuit card (UICC) component, and/or another component configured to store subscription information. In some cases, the UE may be deployed with a SIM component or UICC component that is already configured with the subscription information.

To access the SNPN, the UE may scan or monitor for transmissions that identify the PLMN identifier and the NID of the SNPN. For example, the SNPN (e.g., one or more BSs 110 in the SNPN) may broadcast and/or otherwise transmit the PLMN identifier and the NID of the SNPN so that UEs may discover the SNPN. The UE may determine whether the PLMN identifier and the NID identified in the broadcast or transmission from the SNPN matches the PLMN identifier and the NID in the subscription information stored by the UE. If the PLMN identifier and the NID match, the UE may attempt to register with the SNPN. Once the UE has registered with the SNPN, the SNPN may grant the UE access to various non-public network services hosted by the SNPN.

As indicated above, FIG. 3 is provided as an example. Other examples may differ from what is described with respect to FIG. 3.

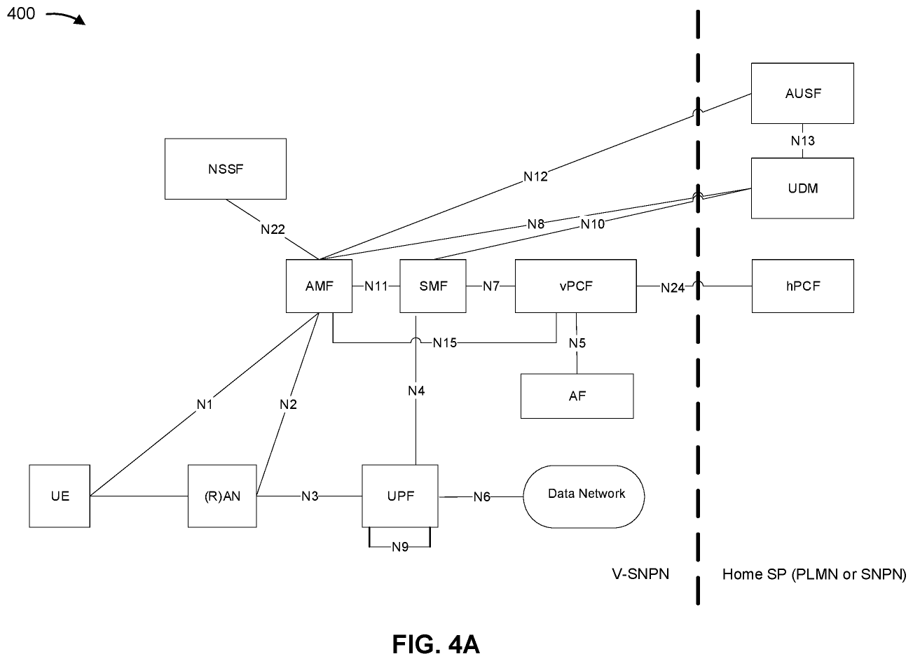

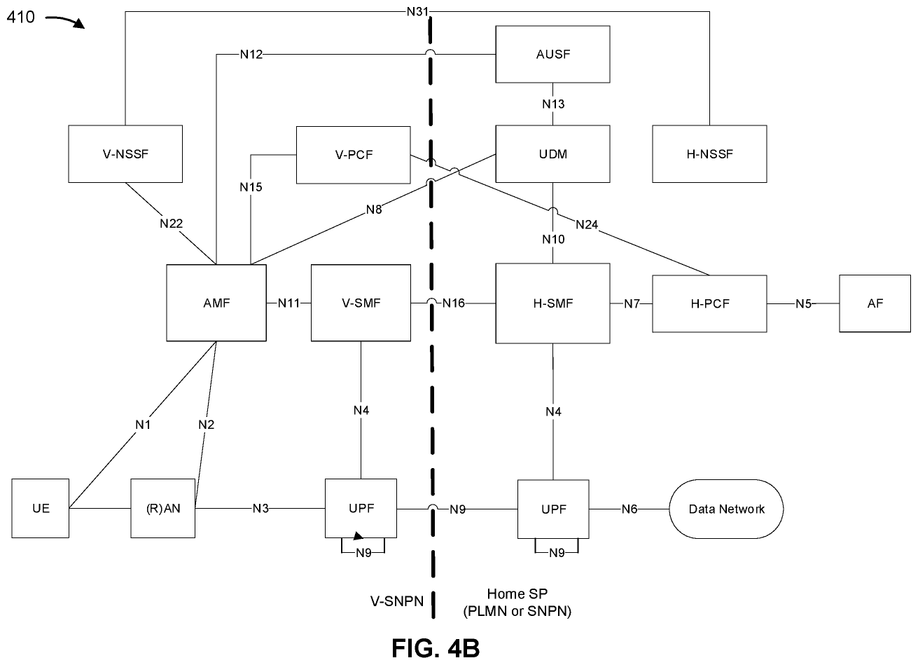

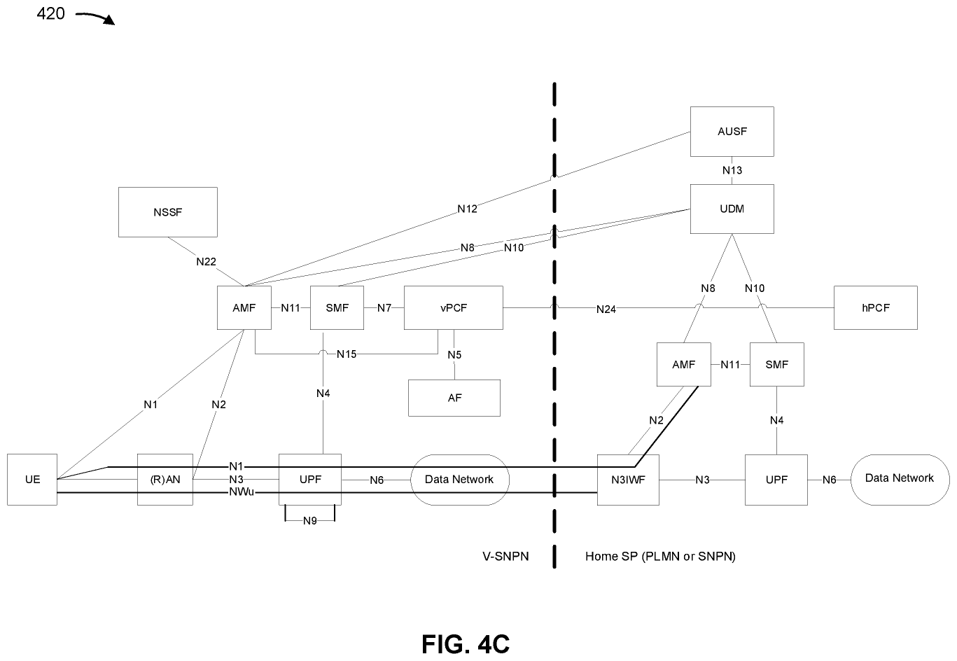

FIGS. 4A-4C are diagrams illustrating examples 400, 410, and 420 of SNPN access, in accordance with various aspects of the present disclosure. In particular, FIGS. 4A-4C show communications between components (e.g., implementing various network functions) of a subscribed wireless network (e.g., a home SP) and an SNPN in connection with a registration procedure of a UE (e.g., UE 120). Accordingly, as part of the registration procedure of the UE, the SNPN (e.g., one or more devices and/or components implementing the SNPN) may establish a connection to the subscribed wireless network (e.g., one or more devices and/or components implementing the subscribed wireless network). For example, based at least in part on an identifier provided by the UE as part of a registration procedure (e.g., a subscription permanent identifier (SUPI), a subscription concealed identifier (SUCI), and/or the like), a device implementing one or more components of the SNPN may determine an identity of the subscribed wireless network and, accordingly, may determine an address (e.g., using a mapping) at which the subscribed wireless network is reachable.

As shown in FIG. 4A, the SNPN may communicate with the subscribed wireless network to perform authentication of the UE and obtain subscription information for the UE. In particular, an AMF of the SNPN may communicate with an AUSF of the subscribed wireless network to authenticate the UE. For example, the AMF may transmit credentials of the UE that were provided with a registration request of the UE. In addition, the AMF and an SMF of the SNPN may communicate with a UDM function of the subscribed wireless network to obtain subscription information for the UE. For example, the AMF and/or the SMF may transmit an identifier of the UE (e.g., a SUPI or a SUCI) that was provided with a registration request of the UE. As shown in FIG. 4A, after registration, the UE may communicate with a data network (e.g., a data network providing non-public network services, and/or the like) via a UPF of the SNPN.

As shown in FIG. 4B, the SNPN may communicate with the subscribed wireless network to perform authentication of the UE and obtain subscription information for the UE, as described above. In particular, an AMF of the SNPN may communicate with an AUSF of the subscribed wireless network to authenticate the UE, as described above. In addition, the AMF may communicate with a UDM component of the subscribed wireless network to obtain subscription information for the UE, as described above. As shown in FIG. 4B, after registration, the UE may communicate with a data network (e.g., the Internet) via the subscribed wireless network. For example, a UPF of the SNPN may forward a session (e.g., a physical data unit (PDU) session) of the UE to a UPF of the subscribed wireless network for termination at the data network via the subscribed wireless network.

As shown in FIG. 4C, the SNPN may communicate with the subscribed wireless network to perform authentication of the UE and obtain subscription information for the UE, as described above. In particular, an AMF of the SNPN may communicate with an AUSF of the subscribed wireless network to authenticate the UE, as described above. In addition, the AMF and an SMF of the SNPN may communicate with a UDM component of the subscribed wireless network to obtain subscription information for the UE, as described above. As shown in FIG. 4C, after registration, the UE may communicate with a data network (e.g., the Internet) via a UPF of the SNPN. As further shown in FIG. 4C, the UE may establish a tunnel, via the data network, to an inter-working function (IWF, shown as N3IWF) of the subscribed wireless network, thereby enabling the UE to access a data network (e.g., for file retrieval) via the UPF of the subscribed wireless network.

As indicated above, FIGS. 4A-4C are provided as examples. Other examples may differ from what is described with respect to FIGS. 4A-4C.

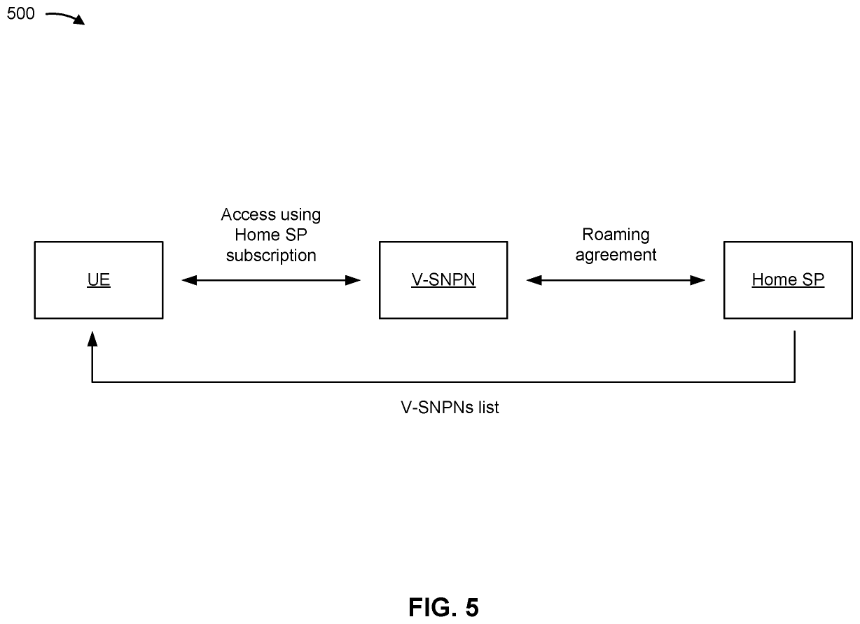

FIG. 5 is a diagram illustrating an example 500 of SNPN roaming, in accordance with various aspects of the present disclosure. As shown in FIG. 5, a UE may be capable of accessing an SNPN implemented by and/or hosted in a wireless network using a subscription for another wireless network (e.g., a home SP). This may be referred to as SNPN roaming. In this case, the SNPN may be referred to as a visited SNPN (V-SNPN).

In some cases, the home SP may configure the UE with a list of one or more SNPNs (e.g., V-SNPNs) that the UE may access when the UE is roaming (e.g., according to a roaming agreement between the home SP and the one or more SNPNs). Accordingly, the V-SNPN may broadcast and/or otherwise transmit an identifier of the V-SNPN (e.g., a PLMN identifier and a NID of the V-SNPN), and the UE may compare the identifier to the UE's list of SNPNs to determine whether the UE may access the V-SNPN using a subscription for the home SP. The UE may attempt registration with the V-SNPN when the comparison results in a match. In some cases, multiple V-SNPN cells may be available, and the UE may select a V-SNPN associated with a highest priority according to the list of SNPNs.

As indicated above, FIG. 5 is provided as an example. Other examples may differ from what is described with respect to FIG. 5.

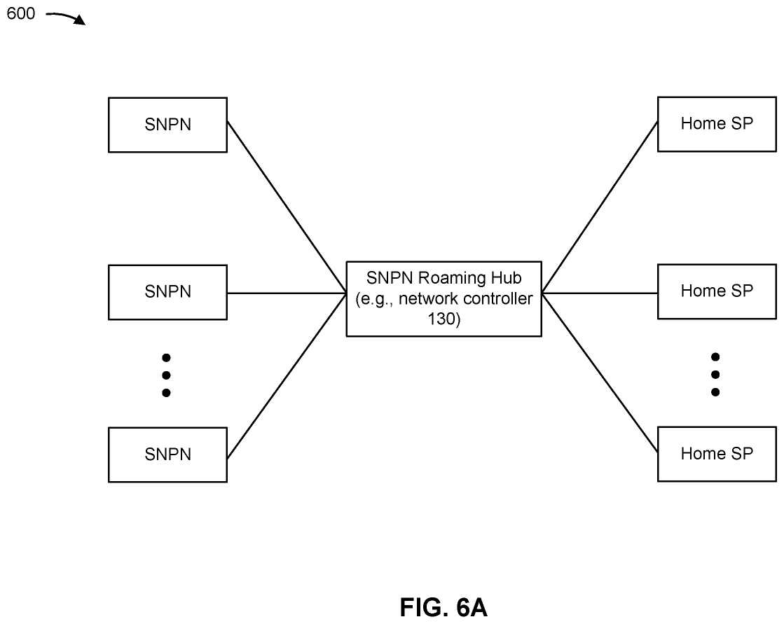

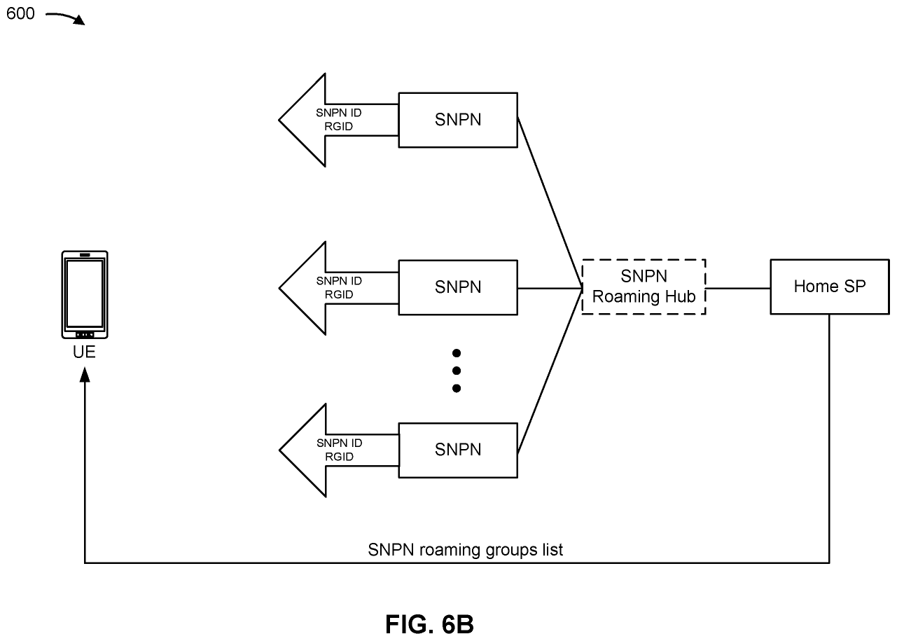

FIGS. 6A and 6B are diagrams illustrating one or more examples 600 of discovery and selection of an SNPN based at least in part on an SNPN roaming group, in accordance with various aspects of the present disclosure.

In some cases, a V-SNPN may broadcast and/or otherwise transmit (e.g., in a system information block (SIB)) the identifiers (e.g., PLMN identifiers and/or NIDs) of the wireless networks (e.g., the home SPs) that the V-SNPN supports (e.g., wireless networks with which the V-SNPN has a roaming agreement). The UE may compare the identifiers to the identifier associated with the UE's home SP subscription in order to determine whether the UE may access the V-SNPN using a subscription for the home SP. The UE may attempt registration with the V-SNPN when the comparison results in a match. In some cases, multiple V-SNPN cells may be available, and the UE may select a V-SNPN of the multiple V-SNPNs. In some cases, if the comparison does not result in a match, the UE may select a V-SNPN that indicates support for access using credentials of another network.

As the quantity of V-SNPNs and the quantity of supported home SPs continue to grow, the relationships between V-SNPNs and home SPs may result in scaling issues. For example, a V-SNPN may need to maintain and update a growing and/or ever-changing list of support home SPs, which may consume large amounts of processing and memory resources for the various devices and/or components included in the V-SNPN. Moreover, as the V-SNPN supports a greater quantity of home SPs, the quantity of home SP identifiers that the V-SNPN broadcasts or transmits also grows, which may result in too much information in the SIB(s) of the V-SNPN and/or may result in increased radio resource consumption.

In some cases, an SNPN roaming group may reduce the complexity and increase the scalability of maintaining lists of supported home SPs for an SNPN (e.g., a V-SNPN). An SNPN roaming group may be identified by a roaming group identifier (RGID) and may be configured to include a plurality of networks (e.g., home SPs).

As shown in FIG. 6A, an SNPN roaming hub (e.g., implemented by a network controller 130) may function as a communication intermediary between the SNPNs and the home SPs. The SNPN roaming hub may be responsible for generating, configuring, and updating SNPN roaming groups and associated RGIDs for the SNPNs and the home SPs, may be responsible for providing indications of the SNPN roaming groups and associated RGIDs to the SNPNs and the home SPs, may be responsible for providing updated SNPN roaming groups and associated RGIDs to the SNPNs and the home SPs, and/or the like.

The SNPN roaming hub may generate and/or configure an SNPN roaming group to include a plurality of home SPs. In some cases, an SNPN roaming group may be subscription based or roaming agreement based. For example, the SNPN roaming hub may generate and/or configure an SNPN roaming group for an SNPN, where the SNPN has a roaming agreement with the home SPs included in the SNPN roaming group. In this case, UEs that are subscribed to the SNPN and any of the home SPs may access the SNPN from the home SP to which the UE is subscribed and via a different home SP in which the SNPN is provided (e.g., through the use of the roaming agreement).

As shown in FIG. 6B, the home SP to which the UE is subscribed (e.g., a BS 110 in the home SP of the UE) may configure the UE with a list of one or more SNPN roaming groups (e.g., one or more SNPN roaming groups that include the home SP). The UE may be permitted to access an SNPN that broadcasts or transmits an RGID associated with an SNPN roaming group via a roaming agreement between the home SP of the UE and another home SP included in the SNPN roaming group.

In some aspects, the one or more SNPN roaming groups may be generated or configured by the SNPN roaming hub, if included, which may transmit an indication of the one or more SNPN roaming groups to the home SP. Moreover, the SNPN roaming hub may transmit, to each SNPN, an indication of the SNPN roaming group(s) supported by the SNPN so that the SNPN can broadcast the RGID(s) of the SNPN roaming group(s) along with the SNPN identifier (e.g., NID) of the SNPN.

Accordingly, an SNPN (e.g., a V-SNPN) may broadcast and/or otherwise transmit the identifiers of SNPN roaming groups supported by the SNPN. The UE may compare the identifiers to the UE's list of SNPN roaming groups to determine whether the UE may access the V-SNPN using a subscription for the UE's home SP. The UE may attempt registration with the SNPN when the comparison results in a match

As indicated above, FIGS. 6A and 6B are provided as one or more examples. Other examples may differ from what is described with respect to FIGS. 6A and 6B.

In some cases, a UE is configured with both a list of SNPNs, as described in connection with FIG. 5, and a list of SNPN roaming groups as described in connection with FIGS. 6A and 6B. In such cases, the UE may not be enabled to determine which list the UE is to use for accessing a V-SNPN, may not be enabled to determine a priority order among V-SNPNs, and/or the like. Some techniques and apparatuses described herein provide a combined list of one or more SNPNs and one or more roaming groups according to a priority order. This may reduce consumption of memory and/or processing resources that would otherwise be used for multiple lists, reduce a complexity of V-SNPN selection by the UE, and/or the like.

A UE may also be capable of accessing a PLMN implemented by and/or hosted in a wireless network using a subscription for another wireless network (e.g., a home SP). This may be referred to as PLMN roaming. In this case, the PLMN may be referred to as a visited PLMN (V-PLMN). Accordingly, a UE may be capable of SNPN roaming, as described above, and PLMN roaming. However, the UE may not be enabled to determine whether to access a V-SNPN or a V-PLMN when the UE is capable of SNPN roaming and PLMN roaming. Moreover, it may be preferable that the UE accesses a V-SNPN in some scenarios and accesses a V-PLMN in other scenarios. Some techniques and apparatuses described herein provide a network-type preference (e.g., relating to V-SNPN access or V-PLMN access) that a UE may use to determine whether to attempt to access a V-SNPN or a V-PLMN when the UE is capable of SNPN roaming and PLMN roaming.

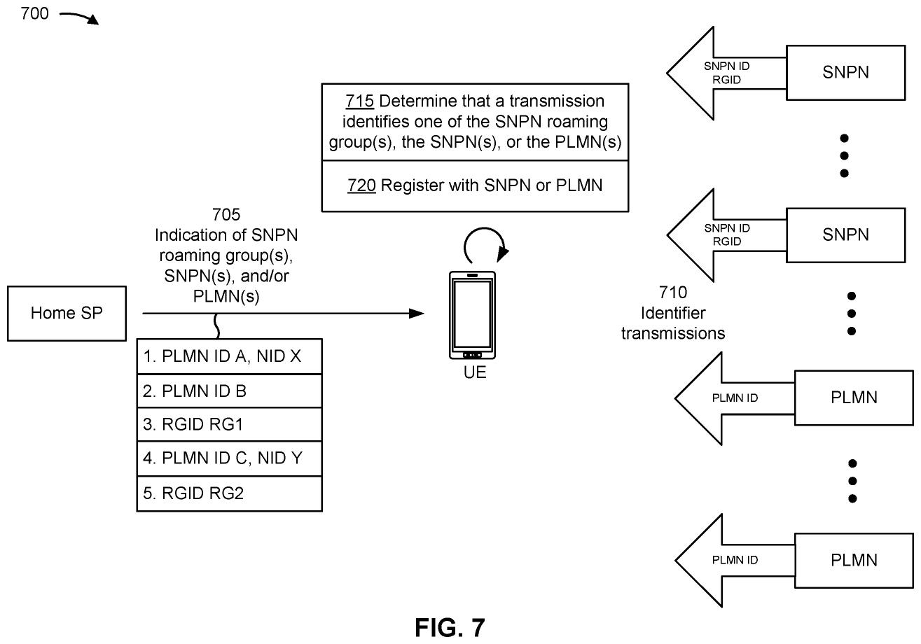

FIG. 7 is a diagram illustrating an example 700 of network selection for a roaming UE, in accordance with various aspects of the present disclosure. As shown in FIG. 7, example 700 may include one or more SNPNs (e.g., V-SNPNs), one or more PLMNs (e.g., V-PLMNs), a home SP, and/or a UE (e.g., a UE 120). In some aspects, one or more of the SNPNs, the PLMNs, or the home SP may correspond to wireless network 100. Moreover, as shown in FIG. 7, the UE may discover and register with an SNPN (e.g., a V-SNPN) or a PLMN (e.g., a V-PLMN).

As shown by reference number 705, the home SP to which the UE is subscribed (e.g., a BS 110 in the home SP of the UE) may transmit, and the UE may receive, an indication of one or more SNPN roaming groups, one or more SNPNs (e.g., to which the UE is not subscribed), and/or one or more PLMNs (e.g., to which the UE is not subscribed). That is, the home SP may configure the UE with a combined list (e.g., a combined preferred visited networks list) of one or more SNPN roaming groups, one or more SNPNs, and/or one or more PLMNs that the UE is to use when roaming. In some aspects, the indication may include one or more SNPN roaming groups and one or more SNPNs. In some aspects, the indication may include one or more SNPN roaming groups, one or more SNPNs, and one or more PLMNs.

The home SP of the UE may be associated with the one or more SNPN roaming groups. For example, the home SP may be included in each of the one or more SNPN roaming groups. In addition, an SNPN roaming group may include one or more other home SPs (e.g., other wireless networks 100). In this case, the home SP of the UE and the other home SPs associated with an SNPN roaming group may have a roaming agreement that permits UEs to access supported SNPNs via roaming on a home SP to which the UE is not subscribed. In some aspects, the one or more SNPN roaming groups may be generated or configured by an SNPN roaming hub, as described above in connection with FIGS. 6A and 6B.

The UE may not be subscribed to the one or more SNPNs and/or the one or more PLMNs. However, the home SP of the UE may have a roaming agreement(s) with the SNPNs and/or the PLMNs. In this case, the UE may be permitted to access the supported SNPNs and/or the PLMNs (e.g., to which the UE is not subscribed) via roaming according to the roaming agreement(s).

In some aspects, the UE may receive the indication of the SNPN roaming group(s), SNPN(s), and/or PLMN(s) as part of a SIM OTA update procedure, as part of a 5G steering of roaming (SoR) procedure, as part of a UE configuration update procedure, in a downlink non-access stratum (NAS) transport message (e.g., used for SoR), and/or the like. The UE may store information identifying the SNPN roaming group(s), SNPN(s), and/or PLMN(s) in a SIM component or UICC component of the UE (e.g., along with subscription information for the UE). Additionally, or alternatively, the UE may store the information in a component (e.g., a hardware component) of the UE other than a SIM component or a UICC component (e.g., in a mobile equipment component of the UE).

In some aspects, additionally and/or alternatively to receiving the indication of the SNPN roaming group(s), SNPN(s), and/or PLMN(s), the UE may be provisioned and/or deployed with a configuration (e.g., a SIM configuration, a UICC configuration, a mobile equipment configuration, and/or the like) that already includes the information identifying the SNPN roaming group(s), SNPN(s), and/or PLMN(s). In this case, updates to the SNPN roaming group(s), SNPN(s), and/or PLMN(s) may be provided to the UE via a SIM OTA update procedure, a 5G SoR procedure, a UE configuration update procedure, a downlink NAS transport message, and/or the like.

In some aspects, the indication of the SNPN roaming group(s), SNPN(s), and/or PLMN(s) may identify respective identifiers for the SNPN roaming group(s), SNPN(s), and/or PLMN(s). An SNPN roaming group may be identified by an RGID, an SNPN may be identified by a PLMN identifier (ID) and a NID, and a PLMN may be identified by a PLMN identifier. Accordingly, the information stored by the UE that identifies the SNPN roaming group(s), SNPN(s), and/or PLMN(s) may include respective identifiers for the SNPN roaming group(s), SNPN(s), and/or PLMN(s).

In some aspects, the indication of the SNPN roaming group(s), SNPN(s), and/or PLMN(s) may further identify a priority order for the SNPN roaming group(s), SNPN(s), and/or PLMN(s). In this case, if the UE is capable of accessing a plurality of SNPNs and/or PLMNs, the UE may select and access the SNPN and/or PLMN associated with the highest ranked SNPN roaming group, SNPN, and/or PLMN, or using other rules and/or parameters that are based at least in part on the priority order.

In some aspects, the indication may include and/or identify a list of the SNPN roaming group(s), SNPN(s), and/or PLMN(s) according to the priority order. Accordingly, the information stored by the UE that identifies the SNPN roaming group(s), SNPN(s), and/or PLMN(s) may be the list of the SNPN roaming group(s), SNPN(s), and/or PLMN(s) according to the priority order.

As shown by reference number 710, the one or more SNPNs and/or the one or more PLMNs (e.g., BSs 110 in the SNPNs and/or the PLMNs) may broadcast and/or otherwise transmit identifiers. For example, the one or more SNPNs may broadcast and/or otherwise transmit SNPN roaming group identifiers (e.g., RGIDs) and/or SNPN identifiers. As another example, the one or more PLMNs may broadcast or otherwise transmit PLMN identifiers.

As shown by reference number 715, to register with an SNPN and/or PLMN, the UE may receive a transmission (e.g., a broadcast, a multicast, a group cast, a unicast, and/or the like) from an SNPN and/or a PLMN and may determine whether the transmission identifies an SNPN roaming group (e.g., an RGID) of the one or more SNPN roaming groups, an SNPN (e.g., an SNPN identifier) of the one or more SNPNs, and/or a PLMN (e.g., a PLMN identifier) of the one or more PLMNs indicated for the UE. As shown by reference number 720, if the UE determines that a transmission from an SNPN or a PLMN identifies an SNPN roaming group, an SNPN, or a PLMN indicated for the UE (e.g., in the list of SNPN roaming group(s), SNPN(s), and/or PLMN(s) stored by the UE), the UE may register with the SNPN or the PLMN.

In some aspects, if the UE receives transmissions from a plurality of SNPNs and/or PLMNs, and each of the transmissions identifies a respective identifier of an SNPN roaming group, an SNPN, and/or a PLMN indicated for the UE, the UE may select the SNPN or PLMN to register with based at least in part on the priority order of the SNPN roaming group(s), SNPN(s), and/or PLMN(s). For example, the UE may register with the SNPN or the PLMN that transmitted an identifier associated with a highest priority among the transmitted identifiers. As an example, if a transmission of a PLMN identifies PLMN ID B (associated with a second-highest priority, as shown), and a transmission of an SNPN identifies RGID RG1 (associated with a third-highest priority, as shown), the UE may register with the PLMN in accordance with the priority order.

In some aspects, the UE may register with the SNPN or the PLMN using one or more of the techniques described above in connection with FIGS. 4A-4C. After registration with the SNPN or the PLMN, the UE may be granted access to communicate with various data networks provided via the SNPN or the PLMN, such as data networks providing non-public network services, the Internet, and/or the like.

In this way, the combined list of SNPN roaming group(s), SNPN(s), and/or PLMN(s) configured for the UE may be used to reduce the complexity associated with SNPN and/or PLMN selection.

As indicated above, FIG. 7 is provided as an example. Other examples may differ from what is described with respect to FIG. 7.

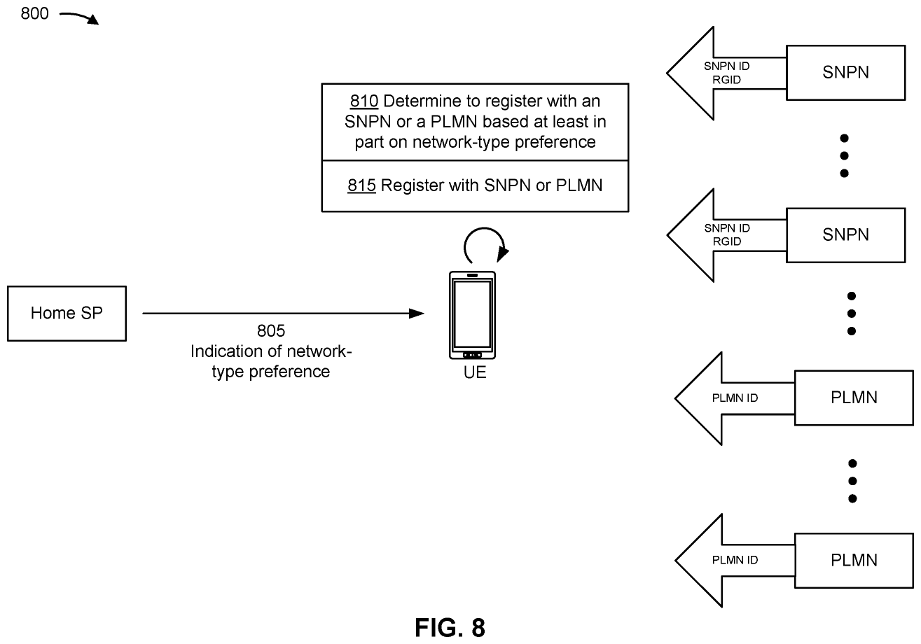

FIG. 8 is a diagram illustrating an example 800 of network selection for a roaming UE, in accordance with various aspects of the present disclosure. As shown in FIG. 8, example 800 may include one or more SNPNs (e.g., V-SNPNs), one or more PLMNs (e.g., V-PLMNs), a home SP, and/or a UE (e.g., a UE 120). In some aspects, one or more of the SNPNs, the PLMNs, or the home SP may correspond to wireless network 100. Moreover, as shown in FIG. 8, the UE may discover and register with an SNPN (e.g., a V-SNPN) or a PLMN (e.g., a V-PLMN).

As shown by reference number 805, the home SP to which the UE is subscribed (e.g., a BS 110 in the home SP of the UE) may transmit, and the UE may receive, an indication of a network-type preference. That is, the home SP may configure the UE with a visited network-type preference that the UE is to use when roaming. The indication of the network-type preference may relate to SNPNs or PLMNs. For example, the indication of the network-type preference may indicate that the UE is to register with a PLMN and not an SNPN (which may be referred to as a PLMN-only network-type preference), that the UE is to register with an SNPN and not a PLMN (which may be referred to as an SNPN-only network-type preference), that the UE is to prioritize registering with a PLMN over registering with an SNPN (which may be referred to as a PLMN-preferred network-type preference), or that the UE is to prioritize registering with an SNPN over registering with a PLMN (which may be referred to as an SNPN- preferred network-type preference).

In some aspects, the UE may receive the indication of the network-type preference as part of a SIM OTA update procedure, as part of a 5G SoR procedure, as part of a UE configuration update procedure, in a downlink NAS transport message, and/or the like, as described above. The UE may store information identifying the network-type preference in a SIM component or UICC component of the UE (e.g., along with subscription information for the UE). Additionally, or alternatively, the UE may store the information in a component (e.g., a hardware component) of the UE other than a SIM component or a UICC component (e.g., in a mobile equipment component of the UE).

In some aspects, additionally and/or alternatively to receiving the indication of the network-type preference, the UE may be provisioned and/or deployed with a configuration (e.g., a SIM configuration, a UICC configuration, a mobile equipment configuration, and/or the like) that already includes the information identifying the network-type preference. In this case, updates to the network-type preference may be provided to the UE via a SIM OTA update procedure, a 5G SoR procedure, a UE configuration update procedure, a downlink NAS transport message, and/or the like.

In some aspects, the UE may be configured with one or more lists of networks that are to be used for roaming. For example, the UE may be configured with a list that identifies (e.g., according to a priority order) one or more SNPN roaming groups (e.g., RGIDs), one or more SNPNs (e.g., SNPN identifiers), and/or one or more PLMNs (e.g., PLMN identifiers). Additionally, or alternatively, the UE may be configured with a list (e.g., a service provider controlled network selector list) that identifies (e.g., according to a priority order) one or more SNPNs (e.g., SNPN identifiers) and/or one or more PLMNs (e.g., PLMN identifiers). In some aspects, the home SP may transmit an indication of the one or more lists of networks, and the UE may store information relating to the one or more lists of networks (e.g., in a SIM component, a UICC component, a mobile equipment component and/or the like), as described above.

As shown by reference number 810, the UE may determine to register with a network (e.g., an SNPN or a PLMN) based at least in part on the network-type preference. In some aspects, the UE may determine to register with a network using the network-type preference based at least in part on a determination that one or more networks, identified by one or more lists of networks configured for the UE, are not available. For example, the UE may determine that respective identifiers, which may be broadcast and/or otherwise transmitted by one or more available networks (e.g., one or more SNPNs and/or PLMNs), as described above, do not match identifiers included in the one or more lists of networks.

In some aspects, the indication of the network-type preference may be PLMN-only or PLMN-preferred, as described above. In this case, the UE may determine to register with a PLMN of the one or more available networks. In some aspects, if the available networks include multiple PLMNs, the UE may select a PLMN associated with a high signal quality (e.g., a signal quality that satisfies a threshold value). In some aspects, the available networks do not include a PLMN, and/or the UE is unable to successfully register with the PLMN(s) of the available networks. In this case, if the indication of the network-type preference is PLMN-preferred, the UE may determine to register with an SNPN of the one or more available networks (e.g., after determining that there are no available PLMNs and/or after unsuccessfully attempting to register with all available PLMNs). In some aspects, the UE may determine to register with an SNPN that broadcasts and/or otherwise transmits an identifier associated with the home SP of the UE, as described above in connection with FIGS. 6A and 6B.

In some aspects, the indication of the network-type preference may be SNPN-only or SNPN-preferred, as described above. In this case, the UE may determine to register with an SNPN of the one or more available networks. For example, the UE may determine to register with an SNPN that broadcasts and/or otherwise transmits an identifier associated with the home SP of the UE. In some aspects, the available networks do not include an SNPN and/or the UE is unable to successfully register with the SNPN(s) of the available networks. In this case, if the indication of the network-type preference is SNPN-preferred, the UE may determine to register with a PLMN of the one or more available networks (e.g., after determining that there are no available SNPNs and/or after unsuccessfully attempting to register with all available SNPNs). In some aspects, if the available networks include multiple PLMNs, the UE may select a PLMN associated with a high signal quality (e.g., a signal quality that satisfies a threshold value).

As shown by reference number 815, if the UE determines an SNPN or a PLMN for registration, according to the network-type preference, the UE may register with the SNPN or the PLMN. In some aspects, the UE may register with the SNPN or the PLMN using one or more of the techniques described above in connection with FIGS. 4A-4C. After registration with the SNPN or the PLMN, the UE may be granted access to communicate with various data networks provided via the SNPN or the PLMN, such as data networks providing non-public network services, the Internet, and/or the like.

In this way, network connectivity of the UE may be improved during roaming, SNPN and/or PLMN operator preferences relating to roaming UEs may be applied to improve network performance, and/or the like.

As indicated above, FIG. 8 is provided as an example. Other examples may differ from what is described with respect to FIG. 8.

FIG. 9 is a diagram illustrating an example process 900 performed, for example, by a UE, in accordance with various aspects of the present disclosure. Example process 900 is an example where the UE (e.g., UE 120 and/or the like) performs operations associated with network selection for a roaming UE.

As shown in FIG. 9, in some aspects, process 900 may include receiving an indication of one or more SNPN roaming groups, associated with a network to which a UE is subscribed, and one or more SNPNs to which the UE is not subscribed (block 910). For example, the UE (e.g., using antenna 252, DEMOD 254, MIMO detector 256, receive processor 258, controller/processor 280, and/or the like) may receive an indication of one or more SNPN roaming groups, associated with a network to which the UE is subscribed, and one or more SNPNs to which the UE is not subscribed, as described above.

As further shown in FIG. 9, in some aspects, process 900 may include determining that a transmission from an SNPN identifies an SNPN roaming group identifier associated with one of the one or more SNPN roaming groups or identifies an SNPN identifier associated with one of the one or more SNPNs (block 920). For example, the UE (e.g., using receive processor 258, controller/processor 280, memory 282, and/or the like) may determine that a transmission from an SNPN identifies an SNPN roaming group identifier associated with one of the one or more SNPN roaming groups or identifies an SNPN identifier associated with one of the one or more SNPNs, as described above.

As further shown in FIG. 9, in some aspects, process 900 may include registering with the SNPN based at least in part on determining that the transmission identifies the SNPN roaming group identifier or the SNPN identifier (block 930). For example, the UE (e.g., using receive processor 258, transmit processor 264, controller/processor 280, memory 282, and/or the like) may register with the SNPN based at least in part on determining that the transmission identifies the SNPN roaming group identifier or the SNPN identifier, as described above.

Process 900 may include additional aspects, such as any single aspect or any combination of aspects described below and/or in connection with one or more other processes described elsewhere herein.

In a first aspect, the indication of the one or more SNPN roaming groups and the one or more SNPNs identifies respective roaming group identifiers associated with the one or more SNPN roaming groups and identifies respective SNPN identifiers associated with the one or more SNPNs.

In a second aspect, alone or in combination with the first aspect, the indication of the one or more SNPN roaming groups and the one or more SNPNs includes a list that identifies a priority order for the one or more SNPN roaming groups and the one or more SNPNs.

In a third aspect, alone or in combination with one or more of the first and second aspects, registering with the SNPN based at least in part on determining that the transmission identifies the SNPN roaming group identifier or the SNPN identifier includes registering with the SNPN based at least in part on the list that identifies the priority order for the one or more SNPN roaming groups and the one or more SNPNs.

In a fourth aspect, alone or in combination with one or more of the first through third aspects, the indication of the one or more SNPN roaming groups and the one or more SNPNs further identifies one or more PLMNs to which the UE is not subscribed.

In a fifth aspect, alone or in combination with one or more of the first through fourth aspects, process 900 includes determining that a transmission from a PLMN identifies a PLMN identifier associated with one of the one or more PLMNs, and the UE is to register with the PLMN instead of the SNPN when the indication assigns a higher priority to the PLMN than a priority assigned to the SNPN.

In a sixth aspect, alone or in combination with one or more of the first through fifth aspects, receiving the indication of the one or more SNPN roaming groups and the one or more SNPNs includes receiving the indication as part of a UE configuration update procedure for the UE or in a downlink NAS transport message.

In a seventh aspect, alone or in combination with one or more of the first through sixth aspects, receiving the indication of the one or more SNPN roaming groups and the one or more SNPNs includes receiving the indication as part of a subscriber identification module over-the-air update procedure or a steering of roaming procedure for the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with various aspects of the present disclosure. Example process 1000 is an example where the UE (e.g., UE 120 and/or the like) performs operations associated with network selection for a roaming UE.

As shown in FIG. 10, in some aspects, process 1000 may include receiving an indication of a network-type preference relating to PLMNs or SNPNs (block 1010). For example, the UE (e.g., using antenna 252, DEMOD 254, MIMO detector 256, receive processor 258, controller/processor 280, and/or the like) may receive an indication of a network-type preference relating to PLMNs or SNPNs, as described above.

As further shown in FIG. 10, in some aspects, process 1000 may include determining to register with a network based at least in part on the network-type preference (block 1020). For example, the UE (e.g., using receive processor 258, transmit processor 264, controller/processor 280, memory 282, and/or the like) may determine to register with a network based at least in part on the network-type preference, as described above.

Process 1000 may include additional aspects, such as any single aspect or any combination of aspects described below and/or in connection with one or more other processes described elsewhere herein.

In a first aspect, the indication of the network-type preference indicates one of: the UE is to register with a PLMN and not an SNPN; the UE is to register with an SNPN and not a PLMN; the UE is to prioritize registering with a PLMN over registering with an SNPN; or the UE is to prioritize registering with an SNPN over registering with a PLMN.

In a second aspect, alone or in combination with the first aspect, determining to register with the network is further based at least in part on a determination that one or more networks available for registration are not included in a list of networks configured for the UE.

In a third aspect, alone or in combination with one or more of the first and second aspects, receiving the indication of the network-type preference includes receiving the indication as part of a UE configuration update procedure or a steering of roaming procedure for the UE.

In a fourth aspect, alone or in combination with one or more of the first through third aspects, receiving the indication of the network-type preference includes receiving the indication as part of a subscriber identification module over-the-air update procedure or a steering of roaming procedure for the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

The following provides an overview of some Aspects of the present disclosure:

Aspect 1: A method of wireless communication performed by a user equipment (UE), comprising: receiving an indication of one or more standalone non-public network (SNPN) roaming groups, associated with a network to which the UE is subscribed, and one or more SNPNs to which the UE is not subscribed; determining that a transmission from an SNPN identifies an SNPN roaming group identifier associated with one of the one or more SNPN roaming groups or identifies an SNPN identifier associated with one of the one or more SNPNs; and registering with the SNPN based at least in part on determining that the transmission identifies the SNPN roaming group identifier or the SNPN identifier.

Aspect 2: The method of Aspect 1, wherein the indication of the one or more SNPN roaming groups and the one or more SNPNs identifies respective roaming group identifiers associated with the one or more SNPN roaming groups and identifies respective SNPN identifiers associated with the one or more SNPNs.

Aspect 3: The method of any of Aspects 1-2, wherein the indication of the one or more SNPN roaming groups and the one or more SNPNs comprises a list that identifies a priority order for the one or more SNPN roaming groups and the one or more SNPNs.

Aspect 4: The method of Aspect 3, wherein registering with the SNPN based at least in part on determining that the transmission identifies the SNPN roaming group identifier or the SNPN identifier comprises: registering with the SNPN based at least in part on the list that identifies the priority order for the one or more SNPN roaming groups and the one or more SNPNs.

Aspect 5: The method of any of Aspects 1-4, wherein the indication of the one or more SNPN roaming groups and the one or more SNPNs further identifies one or more public land mobile networks (PLMNs) to which the UE is not subscribed.

Aspect 6: The method of Aspect 5, further comprising: determining that a transmission from a PLMN identifies a PLMN identifier associated with one of the one or more PLMNs, wherein the UE is to register with the PLMN instead of the SNPN when the indication assigns a higher priority to the PLMN than a priority assigned to the SNPN.

Aspect 7: The method of any of Aspects 1-6, wherein receiving the indication of the one or more SNPN roaming groups and the one or more SNPNs comprises: receiving the indication as part of a UE configuration update procedure for the UE or in a downlink non-access stratum transport message.

Aspect 8: The method of any of Aspects 1-6, wherein receiving the indication of the one or more SNPN roaming groups and the one or more SNPNs comprises: receiving the indication as part of a subscriber identification module over-the-air update procedure or a steering of roaming procedure for the UE.

Aspect 9: A method of wireless communication performed by a user equipment (UE), comprising: receiving an indication of a network-type preference relating to public land mobile networks (PLMNs) or standalone non-public networks (SNPNs); and determining to register with a network based at least in part on the network-type preference.

Aspect 10: The method of Aspect 9, wherein the indication of the network-type preference indicates one of: the UE is to register with a PLMN and not an SNPN; the UE is to register with an SNPN and not a PLMN; the UE is to prioritize registering with a PLMN over registering with an SNPN; or the UE is to prioritize registering with an SNPN over registering with a PLMN.

Aspect 11: The method of any of Aspects 9-10, wherein determining to register with the network is further based at least in part on a determination that one or more networks available for registration are not included in a list of networks configured for the UE.

Aspect 12: The method of any of Aspects 9-11, wherein receiving the indication of the network-type preference comprises: receiving the indication as part of a UE configuration update procedure or a steering of roaming procedure for the UE.

Aspect 13: The method of any of Aspects 9-11, wherein receiving the indication of the network-type preference comprises: receiving the indication as part of a subscriber identification module over-the-air update procedure or a steering of roaming procedure for the UE.

Aspect 14: An apparatus for wireless communication at a device, comprising a processor; memory coupled with the processor; and instructions stored in the memory and executable by the processor to cause the apparatus to perform the method of one or more Aspects of Aspects 1-8.

Aspect 15: A device for wireless communication, comprising a memory and one or more processors coupled to the memory, the memory and the one or more processors configured to perform the method of one or more Aspects of Aspects 1-8.

Aspect 16: An apparatus for wireless communication, comprising at least one means for performing the method of one or more Aspects of Aspects 1-8.

Aspect 17: A non-transitory computer-readable medium storing code for wireless communication, the code comprising instructions executable by a processor to perform the method of one or more Aspects of Aspects 1-8.

Aspect 18: A non-transitory computer-readable medium storing a set of instructions for wireless communication, the set of instructions comprising one or more instructions that, when executed by one or more processors of a device, cause the device to perform the method of one or more Aspects of Aspects 1-8.

Aspect 19: An apparatus for wireless communication at a device, comprising a processor; memory coupled with the processor; and instructions stored in the memory and executable by the processor to cause the apparatus to perform the method of one or more Aspects of Aspects 9-13.

Aspect 20: A device for wireless communication, comprising a memory and one or more processors coupled to the memory, the memory and the one or more processors configured to perform the method of one or more Aspects of Aspects 9-13.

Aspect 21: An apparatus for wireless communication, comprising at least one means for performing the method of one or more Aspects of Aspects 9-13.

Aspect 22: A non-transitory computer-readable medium storing code for wireless communication, the code comprising instructions executable by a processor to perform the method of one or more Aspects of Aspects 9-13.

Aspect 23: A non-transitory computer-readable medium storing a set of instructions for wireless communication, the set of instructions comprising one or more instructions that, when executed by one or more processors of a device, cause the device to perform the method of one or more Aspects of Aspects 9-13.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving an indication of one or more standalone non-public network (SNPN) roaming groups, associated with a network to which the UE is subscribed, and one or more SNPNs to which the UE is not subscribed;
determining that a transmission from an SNPN identifies an SNPN roaming group identifier associated with one of the one or more SNPN roaming groups or identifies an SNPN identifier associated with one of the one or more SNPNs; and
registering with the SNPN based at least in part on determining that the transmission identifies the SNPN roaming group identifier or the SNPN identifier.

2. The method of claim 1, wherein the indication of the one or more SNPN roaming groups and the one or more SNPNs identifies respective roaming group identifiers associated with the one or more SNPN roaming groups and identifies respective SNPN identifiers associated with the one or more SNPNs.

3. The method of claim 1, wherein the indication of the one or more SNPN roaming groups and the one or more SNPNs comprises a list that identifies a priority order for the one or more SNPN roaming groups and the one or more SNPNs.

4. The method of claim 3, wherein registering with the SNPN based at least in part on determining that the transmission identifies the SNPN roaming group identifier or the SNPN identifier comprises:
registering with the SNPN based at least in part on the list that identifies the priority order for the one or more SNPN roaming groups and the one or more SNPNs.

5. The method of claim 1, wherein the indication of the one or more SNPN roaming groups and the one or more SNPNs further identifies one or more public land mobile networks (PLMNs) to which the UE is not subscribed.

6. The method of claim 5, further comprising:
determining that a transmission from a PLMN identifies a PLMN identifier associated with one of the one or more PLMNs,
wherein the UE is to register with the PLMN instead of the SNPN when the indication assigns a higher priority to the PLMN than a priority assigned to the SNPN.

7. The method of claim 1, wherein receiving the indication of the one or more SNPN roaming groups and the one or more SNPNs comprises:
receiving the indication as part of a UE configuration update procedure for the UE or in a downlink non-access stratum transport message.

8. The method of claim 1, wherein receiving the indication of the one or more SNPN roaming groups and the one or more SNPNs comprises:
receiving the indication as part of a subscriber identification module over-the-air update procedure or a steering of roaming procedure for the UE.

9. A method of wireless communication performed by a user equipment (UE), comprising:
receiving an indication of a network-type preference relating to public land mobile networks (PLMNs) or standalone non-public networks (SNPNs); and
determining to register with a network based at least in part on the network-type preference.

10. The method of claim 9, wherein the indication of the network-type preference indicates one of:
the UE is to register with a PLMN and not an SNPN;
the UE is to register with an SNPN and not a PLMN;
the UE is to prioritize registering with a PLMN over registering with an SNPN; or
the UE is to prioritize registering with an SNPN over registering with a PLMN.

11. The method of claim 9, wherein determining to register with the network is further based at least in part on a determination that one or more networks available for registration are not included in a list of networks configured for the UE.

12. The method of claim 9, wherein receiving the indication of the network-type preference comprises:
receiving the indication as part of a UE configuration update procedure or a steering of roaming procedure for the UE.

13. The method of claim 9, wherein receiving the indication of the network-type preference comprises:
receiving the indication as part of a subscriber identification module over-the-air update procedure or a steering of roaming procedure for the UE.

14. A user equipment (UE) for wireless communication, comprising:
a memory; and
one or more processors operatively coupled to the memory, the memory and the one or more processors configured to:
receive an indication of one or more standalone non-public network (SNPN) roaming groups, associated with a network to which the UE is subscribed, and one or more SNPNs to which the UE is not subscribed;
determine that a transmission from an SNPN identifies an SNPN roaming group identifier associated with one of the one or more SNPN roaming groups or identifies an SNPN identifier associated with one of the one or more SNPNs; and
register with the SNPN based at least in part on determining that the transmission identifies the SNPN roaming group identifier or the SNPN identifier.

15. The UE of claim 14, wherein the indication of the one or more SNPN roaming groups and the one or more SNPNs identifies respective roaming group identifiers associated with the one or more SNPN roaming groups and identifies respective SNPN identifiers associated with the one or more SNPNs.

16. The UE of claim 14, wherein the indication of the one or more SNPN roaming groups and the one or more SNPNs comprises a list that identifies a priority order for the one or more SNPN roaming groups and the one or more SNPNs.

17. The UE of claim 16, wherein the memory and the one or more processors, to register with the SNPN based at least in part on determining that the transmission identifies the SNPN roaming group identifier or the SNPN identifier, are configured to:
register with the SNPN based at least in part on the list that identifies the priority order for the one or more SNPN roaming groups and the one or more SNPNs.

18. The UE of claim 14, wherein the indication of the one or more SNPN roaming groups and the one or more SNPNs further identifies one or more public land mobile networks (PLMNs) to which the UE is not subscribed.

19. The UE of claim 18, wherein the memory and the one or more processors are further configured to:
determine that a transmission from a PLMN identifies a PLMN identifier associated with one of the one or more PLMNs,
wherein the UE is to register with the PLMN instead of the SNPN when the indication assigns a higher priority to the PLMN than a priority assigned to the SNPN.

20. The UE of claim 14, wherein the memory and the one or more processors, to receive the indication of the one or more SNPN roaming groups and the one or more SNPNs, are configured to:
receive the indication as part of a UE configuration update procedure for the UE or in a downlink non-access stratum transport message.

21. The UE of claim 14, wherein the memory and the one or more processors, to receive the indication of the one or more SNPN roaming groups and the one or more SNPNs, are configured to:
receive the indication as part of a subscriber identification module over-the-air update procedure or a steering of roaming procedure for the UE.

22. A user equipment (UE) for wireless communication, comprising:
a memory; and
one or more processors operatively coupled to the memory, the memory and the one or more processors configured to:
receive an indication of a network-type preference relating to public land mobile networks (PLMNs) or standalone non-public networks (SNPNs); and
determine to register with a network based at least in part on the network-type preference.

23. The UE of claim 22, wherein the indication of the network-type preference indicates one of:
the UE is to register with a PLMN and not an SNPN;
the UE is to register with an SNPN and not a PLMN;
the UE is to prioritize registering with a PLMN over registering with an SNPN; or
the UE is to prioritize registering with an SNPN over registering with a PLMN.

24. The UE of claim 22, wherein determining to register with the network is further based at least in part on a determination that one or more networks available for registration are not included in a list of networks configured for the UE.

25. The UE of claim 22, wherein the memory and the one or more processors, to receive the indication of the network-type preference, are configured to:
receive the indication as part of a UE configuration update procedure or a steering of roaming procedure for the UE.

26. The UE of claim 22, wherein the memory and the one or more processors, to receive the indication of the network-type preference, are configured to:
receive the indication as part of a subscriber identification module over-the-air update procedure or a steering of roaming procedure for the UE.

27.-30. (canceled)
